(19) United States
(12) Patent Application Publication
(10) Pub. No.: US 2016/0153233 A1
(43) Pub. Date: Jun. 2, 2016

(54) Hunting ladder guard

(71) Applicant: Tony R. Young, Mount Juliet, TN (US)

(72) Inventor: Tony R. Young, Mount Juliet, TN (US)

(21) Appl. No.: 14/558,533

(22) Filed: Dec. 2, 2014

(51) Int. Cl. E06C 7/00

(52) U.S. Cl. CPC E06C 7/006

(57) ABSTRACT

A ladder guard to prevent access to a hunting ladder and other types of ladders, include: a ladder guard plate, further including a plate hook, configured as an inward protruding hook that attaches to a rung of the ladder; at least two bracket apertures; and a bracket; such that the bracket with upper and lower legs, each further comprising a pad lock aperture; such ladder guard plate attaches with the plate hook to an upper rung of the ladder; and the bracket locks the guard plate to a lower rung of the ladder, with a pad lock. Also disclosed is a ladder guard, including a plate hook and two bracket apertures, such that the ladder guard is locked to a ladder using an adjustable shackle padlock. The ladder guard can further include a plate cut-out, and can be painted with camouflage colors.

### CROSS-REFERENCE TO RELATED APPLICATIONS

N/A

### FIELD OF THE INVENTION

The present invention relates generally to the field of ladders and devices for ladders. More particularly, the present invention relates to a protective ladder guard for hunting stands to prevent unauthorized persons from ascending the ladder to reach the hunting stand platform in the owner's absence.

### BACKGROUND OF THE INVENTION

The use of ladder hunting stands, which provide an elevated platform above the ground while hunting wild game animals, is well documented. There are numerous commercially available ladder tree stands, tri-pod stands, elevated modular stands, automated game feeder systems and the like, which provide access to an elevated platform or enclosure relative to the ground, using an integral ladder for climbing. While tree stand manufacturers produce a wide variety of ladder stands, they do not provide devices designed to prevent unauthorized persons from climbing the ladder to reach the hunting platform in the owner's absence. Such a device would prevent trespassing, the poaching of wild game animals, and the theft or vandalism of the tree stand or the tree stand accessories. As a result, demand exists for a simple, portable, convenient, inexpensive protective device, designed to prevent unauthorized persons from ascending the ladder to reach a hunting platform above.

The unauthorized climbing of ladder hunting stands is a problem many hunters face. This unwelcome behavior may often result in the theft of the hunting stand, hunting stand accessories or other valuable personal property, and facilitates the poaching of wild game animals. Many tri-pod, elevated modular stands and automated game feeder systems have further refinements of value also posing a risk of theft or vandalism. The aftermath of such trespassing activity continues to be a source of great frustration to honest and ethical hunters.

Ladder guards, which deter unauthorized ladder climbing are well known. U.S. Pat. Nos. 7,793,759 to Aiken, 7,717,231 to Horton, 5,441,126 to Orrick, 4,126,206 to Becnel, and 3,968,857 to Bryan are examples representing endeavors to block access to a plurality of rungs to prevent unauthorized climbing of ladders. While such devices and methods suit their intended purpose well for use with commercial ladders, step ladders, swimming pool ladders and the like, or for ladders of a type permanently secured to tall buildings, radio towers, storage tanks and the like, they are not satisfactory for use with modern ladder hunting stands, and do not effectively solve many specific problems faced by hunters.

One solution, the Vital-Security™ slide/lock by Vital Zone™, requires permanent structural modifications be made to the lower bottom two sections from the original tree stand ladder, which incorporate a set of sleeves and hinges now integral to the intersecting ladder columns, locking pin mechanisms and padlocks. In use, both hinge mechanisms are first unlocked and then the protective sleeves are raised to allow the bottom section of the ladder to be folded upward to connect with a receiver housing integral to the next uppermost section of the ladder, allowing the hinge mechanism to be secured using a locking pin, and then be finally secured using a padlock. To lower the ladder section and return it to ground level, the process is reversed, thus allowing access to the ladder.

Another solution, manufactured by Primal Vantage™, requires permanent replacement of the lower bottom section from the original tree stand ladder, with a new section of ladder, having a removable square framed insert having two rungs welded horizontally inside the frame, requiring four long threaded bolts to be passed through the column from the outside and secured into four threaded receiver holes integral to the square framed insert. To prevent climbing the ladder, the four long bolts must be removed and retained for later use, the insert section must be removed, and transported to and from the hunting stand each time. The process is reversed to reinstall the section, thereby allowing access to the ladder.

Many hunters reject such solutions because of the many potential safety problems and mechanical difficulties encountered while attempting to retrofit a ladder hunting stand that has already been installed. In the case of ladder tree stands, the ladder supplied by the manufacturer is an integral component of the product's design, thus any post installation modifications could affect the tree stand's structural integrity. Once connected and installed, each section of the ladder serves to support the next section sequentially supporting the ladder structure and the tree stand platform. Removing a section of the ladder is risky and difficult post installation due to the difficulty of separating the reverse interconnecting sections, and compounded by the total combined weight of downward forces being applied by the mass of the ladder and tree stand platform. Any attempt to remove the ladder or to rotate a section of the ladder out of the way could negate the structural support element designed for the ladder thus affecting platform sturdiness, allowing other ladder sections to separate or allowing the hunting platform itself to shift position on the tree. Undermining the safety and stability of the tree stand platform in this manner could lead to a potentially unsafe or dangerous situation, especially if the ladder or platform becomes loosened or dislodged from the tree while in use. Should an unfortunate accident or injury occur, the hunter also bears risk of liability should an insurance claim ensue. Potential remedies could also be found limited simply because structural modifications were made to the tree stand after purchase.

Another problem encountered is that these solutions require several time consuming, intricate, multi-step tasks, which must be completed with a certain degree of precision, and which must be performed safely every time the hunter enters or leaves the area. In addition, it is highly desirable to occupy the hunting stand well before sunrise and depart the area after sunset, thereby increasing the difficulty in performance of these tasks in darkness, thus reducing the safety margin required to perform such tasks. In addition, maintaining total quiet of the surrounding area is also an essential element for successful game hunting. It is doubtful these tasks can be accomplished consistently, quickly, and safely in the dark, without making unwanted metallic noises, which undoubtedly will disturb the wild game animals in the surrounding area. In the case of tri-pod hunting stands or elevated modular houses, the problem encountered is that attempting to retrofit the ladder is likely not a practical solution, because the entire ladder is typically welded to the tri-pod frame or modular structure.

As such, considering the foregoing, it may be appreciated that there continues to be a need for novel and improved devices and methods for preventing access to ladder hunting stands, which solves the aforementioned problems, protects the private property of hunters and prevents poaching of wild game animals.

### SUMMARY OF THE INVENTION

The foregoing needs are met, to a great extent, by the present invention, wherein in aspects of this invention, enhancements are provided to the existing model of ladder guards.

Aspects of the present invention relate to a hunting ladder guard for hunting ladder stands, tri-pod stands, modular hunting stands and the like.

In related aspects, the hunting ladder guard provides a simple yet effective protective ladder guard device to prevent unauthorized persons from ascending the ladder to reach the hunting stand platform in the owner's absence, thereby preventing trespassing, theft, vandalism and poaching of wild game animals.

In related aspects, the hunting ladder guard is designed to secure most hunting ladder stands and tri-pod ladder stand designs.

In an aspect, a hunting ladder guard, can include:
a. a ladder guard plate, further including
   i. a plate hook, which is connected to an upper end of the ladder guard plate; is configured as an inward protruding hook that attaches on to an upper rung of a hunting ladder;
ii. two or more bracket apertures; and
   b. a bracket;
such that a lower end of the ladder guard can be attached to a lower rung, and the bracket inserted through two consecutive bracket apertures, which are positioned such that an upper leg of the bracket reaches behind and over the lower rung, and a lower leg of the bracket reaches behind and under the lower rung, such that a pad lock can be inserted through pad lock apertures in the upper and lower legs of the bracket, thereby locking the ladder guard plate in place on the hunting ladder.

In related aspects, the hunting ladder guard is designed to be inexpensive, lightweight, sturdy, weatherproof, convenient, easy to transport, and easy to use. In further related aspects, it reduces risk of potential serious injury by not requiring the hunter to retro fit, disassemble or reassemble the ladder stand sections because the ladder or hunting platform is never retracted, replaced or moved, and thus does not undermine the hunting stand structural integrity.

In other related aspects, the hunting ladder guard requires no special tools, or installation or removal of nuts and bolts, and complex repetitive installation and removal tasks are reduced to a minimum.

In other related aspects, the hunting ladder guard allows hunters to quickly and quietly unlock the device with a minimum of effort, while standing on the ground, while working in darkness and without disturbing nearby game animals, place the accessory on the ground while hunting, and quickly, easily and quietly reinstall and secure the device before departing the area. Further, in related aspects, the hunting ladder guard provides year round protection, should a hunter decide to leave the hunting stand in place during the off-season.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 illustrates a perspective view of a ladder guard installed on a hunting ladder, according to an embodiment of the invention.

FIG. 2 illustrates a perspective view of a ladder guard before installation on a ladder, according to an embodiment of the invention.

FIG. 3 illustrates a rear perspective view of a ladder guard installed on a ladder, according to an embodiment of the invention.

FIG. 4 illustrates a front perspective view of a ladder guard plate, according to an embodiment of the invention.

FIG. 5 illustrates a rear perspective view of a ladder guard plate, according to an embodiment of the invention.

FIG. 6 illustrates a perspective view of a bracket of a ladder guard, according to an embodiment of the invention.

FIG. 7 illustrates a side, partially center-cut view of a section of a hunting ladder guard, according to an embodiment of the invention.

FIG. 8 illustrates a perspective view of a ladder guard, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

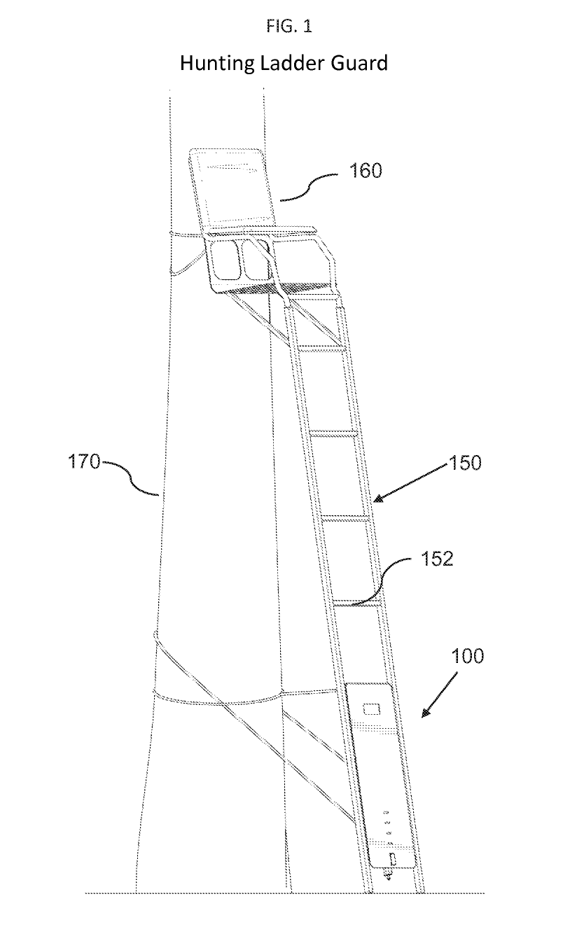

In the following, we describe the structure of an embodiment of a hunting ladder guard 100 with reference to FIG. 1, in such manner that like reference numerals refer to like components throughout; a convention that we shall employ for the remainder of this specification.

In an embodiment, as illustrated in FIG. 1, a hunting ladder guard 100 can be installed on a hunting ladder 150, such that it prevents a person who is not authorized to use the hunting ladder 150 from climbing up the hunting ladder, by covering a plurality of rungs of the ladder 150. FIG. 1 shows the hunting ladder guard 100 installed on a conventional hunting ladder 150, wherein the hunting ladder is installed on a tree 170, with a chair 160 positioned at the end of the hunting ladder 150, such that the chair 160 is resting against and secured to the tree.

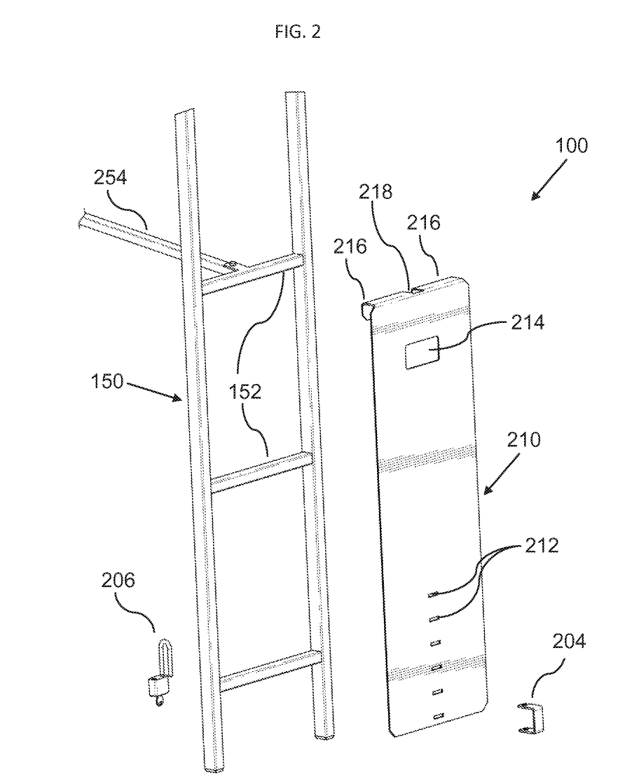

In a related embodiment, as illustrated in FIG. 2, a hunting ladder guard 100, can include:
a. a ladder guard plate 210, further including
   i. a plate hook 216, which is connected to an upper end of the ladder guard plate 210; such that the plate hook 216 is configured as an inward protruding hook that can attach on to a rung 152 of the hunting ladder 150;
   ii. at least two bracket apertures 212; and
b. a bracket 204;

such that the upper end of ladder guard plate can be attached to an upper rung 152 of a ladder 150 using the plate hook 216, and a lower end of the ladder guard 100 can be securely attached to a lower rung 152 of the hunting ladder 150, such that the bracket is inserted through two consecutive bracket apertures 212, which are positioned such that an upper leg of the bracket 204 reaches behind and over the lower rung 152, and a lower leg of the bracket 204 reaches behind and under the lower rung 152, such that a pad lock 206 can be inserted through pad lock apertures in the upper and lower legs of the bracket 204, thereby locking the bracket in place around the lower rung, and thereby locking the lower end of the hunting ladder guard 100 in place, attached to the lower rung 152.

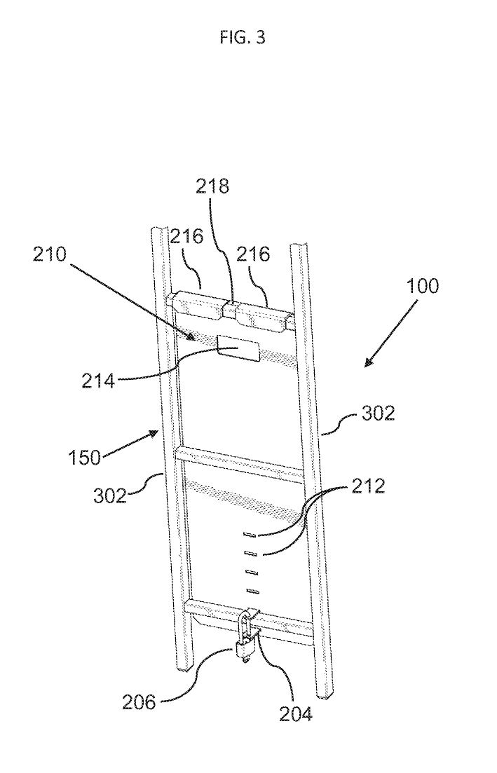

In a related embodiment, FIG. 3 shows a rear view of a hunting ladder guard 100 installed on a ladder 150.

In related embodiments, as shown in FIG. 3, the ladder guard plate 210 when attached to a ladder 150, can be configured to be inside vertical side columns 302 of the ladder such that a gap width between a column 302 and a vertical side of the ladder guard plate 210 is no more than 1-2 inches. A ladder guard plate 210 can thereby fit to ladders of varying width, with some variation of the gap between the vertical sides of the ladder guard plate 210 and the columns 302 of the ladder.

In further related alternative embodiments, a hunting ladder guard 100 can be configured such that a main surface of the ladder guard plate 210 covers the vertical side columns 302.

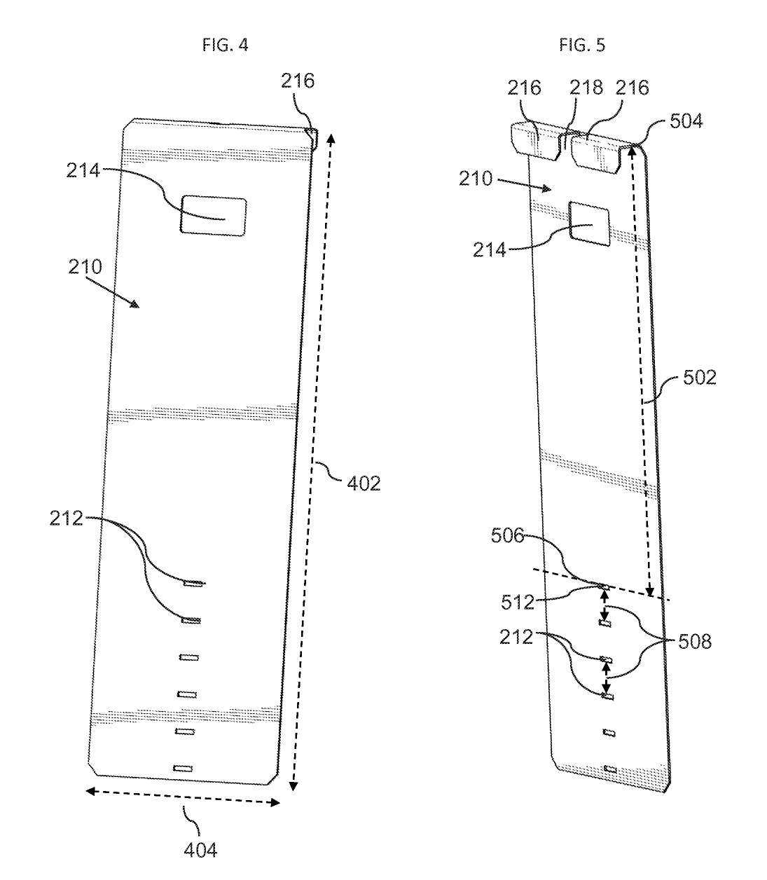

In a related embodiment, FIG. 4 shows a front perspective view of a hunting ladder guard plate 210.

In a related embodiment, FIG. 5 shows a rear perspective view of a hunting ladder guard plate 210. The plate hook 216 is in this embodiment configured as two separate plate hooks 216, separated by a plate hook aperture 218, which can provide space for an attachment on a rung, such as a ladder stabilizer 254, as shown on FIG. 2.

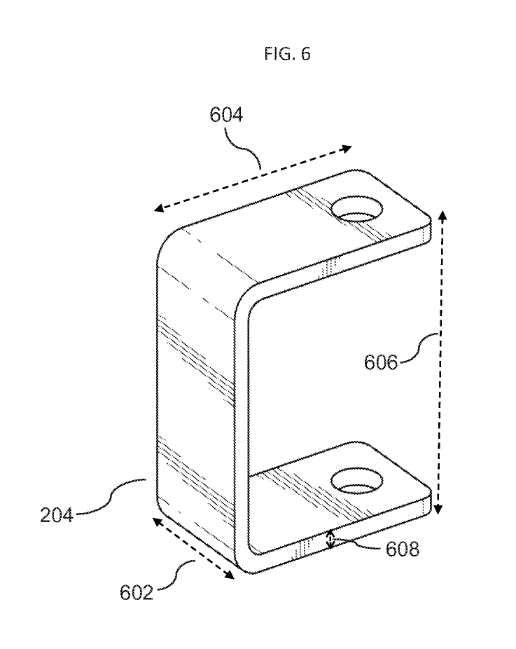

In a related embodiment, FIG. 6 shows a close-up perspective view of a bracket 204, which is substantially u-shaped, with parallel legs extending rearwards. Here, the u-shape of the bracket 204 is rectangular with rounded corners, but the substantially u-shaped configuration of the bracket 204 can alternatively be rectangular with sharp corners or be non-rectangular and fully rounded.

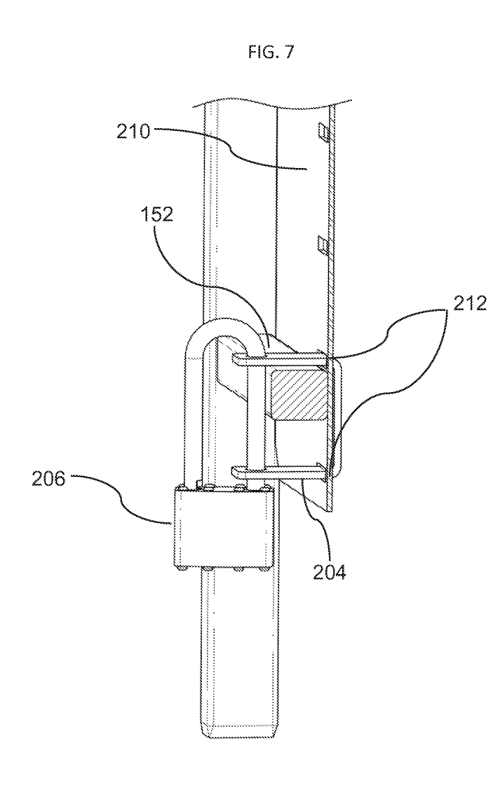

In a related embodiment, FIG. 7 shows a side, partially center-cut view of a section of a hunting ladder guard 100, showing a ladder guard plate 210, mounted to a rung 152, with a bracket 204 inserted through bracket apertures 212, and locked in place with a pad lock 206.

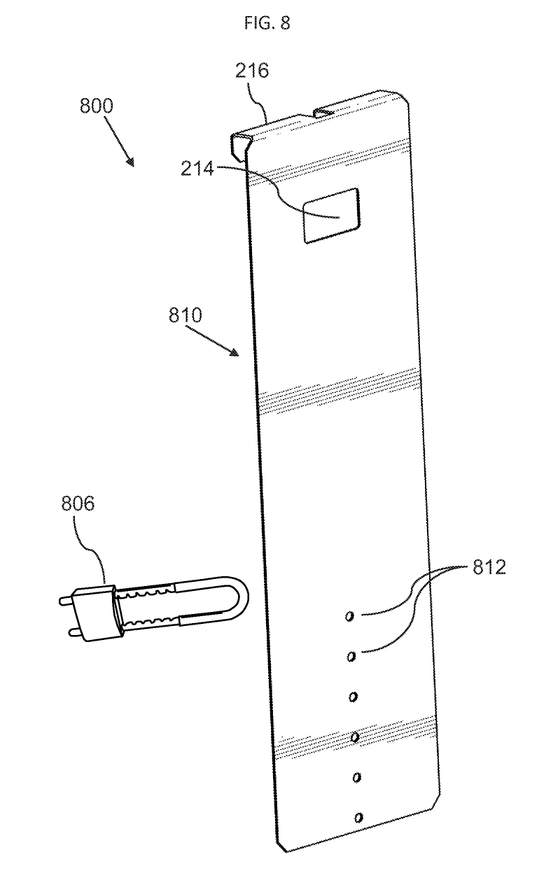

In a related embodiment, FIG. 8 shows a front perspective view of a hunting ladder guard 800, wherein the bracket apertures 812 are circular to be used with an adjustable shackle padlock 806, such that the upper end of ladder guard plate can be attached to an upper rung 152 of a ladder 150 using the plate hook 216, and a lower end of the ladder guard 800 can be securely attached to a lower rung 152 of the ladder 150, such that legs of an adjustable shackle padlock 806 are inserted through two consecutive bracket apertures 812, thereby locking the adjustable shackle padlock 806 in place around the lower rung, and thereby locking the lower end of the ladder guard 100 in place, attached to the lower rung 152.

In a related embodiment, the hunting ladder guard 800 can be used with a chain or cable inserted through bracket apertures 812 and secured in place around a rung 152 of a ladder 150 with a padlock, or the hunting ladder guard 800 can be secured with a cable lock, or similar type of locking device.

In a related embodiment, the bracket apertures 812 can be quadratic, rectangular, ellipsoid, or of other suitable shape, to facilitate use of a compatible locking device.

In various related embodiments, the hunting ladder guard 100 can be configured:
a. such that the ladder guard plate 210 is manufactured in a solid, rectangular shape, one piece design;
b. to fit ladder rungs and tripod rungs in a plurality of column widths and rung height;
c. such that the plate hook 216 fits snugly over and is supported by the plurality of rectangular and circular rung designs of conventional ladders;
d. such that the ladder guard plate 210, when properly installed, blocks at least three consecutive ladder rungs 152.
e. to be sturdy, lightweight, weatherproof, and portable;
f. in a plurality of sizes to fit a plurality of ladder size, including non-standard ladder column widths; and/or
g. with rounded corners, and no sharp edges, for safety and esthetic appeal.

In a related embodiment, the ladder guard plate 210 can further include a plate cutout 214, which can be used as a carrying handle and for ease of positioning the device over objects protruding from the ladder 150.

In a related embodiment, the ladder guard plate 210 and the bracket 204 can be manufactured from metal, such as a high-strength aluminum alloy or stainless steel.

In a related embodiment, the ladder guard plate 210 and the bracket 204 can be painted with a camouflage colored powder coat finish.

In a related first example embodiment, as illustrated in FIG. 4, the ladder guard plate 210 can have a length 402 of substantially 34.5″and a width 404 of substantially 11.75″, which will fit standard 14″ wide ladders 150.

In a related second example embodiment, the ladder guard plate 210 can have a length 402 of substantially 34.5″and a width 404 of substantially 16″.

In a related third example embodiment, illustrated in FIG. 5, which is compatible with both the first and the second example embodiment, an upper side of the plate hook 216 is flush with a top edge of the ladder guard plate 210, and a horizontal level distance 502 from an upper inside 504 of the plate hook 216 to an upper edge 506 of the highest positioned bracket aperture 512 is substantially 23.75″.Additionally, as illustrated in FIG. 6, the bracket 204 can be substantially 1″ wide 602, by substantially 1.75″ deep 604, by substantially 2.125″ high 606, with a thickness 608 of substantially ⅛″. Correspondingly, each bracket aperture 212 can be substantially 1.25″ wide by substantially ¼″ high, with a 1.75″ distance 508 between each of a lower edge of a first bracket aperture 212 to the higher edge of a next-following second bracket aperture, whereby a bracket 204 can fit if the rung step height is not exactly 12″ and is less than 13″. The third example embodiment can fit a ladder 150 with a 12″ rung step height, providing 0.125″ wiggle room for the bracket.

In a related embodiment, in a method of installing the hunting ladder guard 100, a user can be facing a ladder stand and hang the cover plate on a ladder rung, at approximately shoulder height.

The many features and advantages of the invention are apparent from the detailed specification, and thus, it is intended by the appended claims to cover all such features and advantages of the invention, which fall within the true spirit and scope of the invention.

Many such alternative configurations are readily apparent, and should be considered fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention.

What is claimed is:

1. A ladder guard to prevent access to a ladder, comprising:
a. a ladder guard plate, further including
i. a plate hook, which is connected to an upper end of the ladder guard plate, such that the plate hook is configured as an inward protruding hook that attaches to a rung of the ladder;
ii. at least two bracket apertures; and
b. a bracket; wherein the bracket further includes upper and lower legs, each further comprising a pad lock aperture;
such that an upper end of the ladder guard plate is attached to an upper rung of the ladder using the plate hook;
and a lower end of the ladder guard is attached to a lower rung of the hunting ladder, such that the bracket is inserted through two consecutive bracket apertures, which are positioned such that the upper leg of the bracket reaches behind and over the lower rung, and a lower leg of the bracket reaches behind and under the lower rung;
such that a pad lock is inserted through the pad lock apertures in the upper and lower legs of the bracket, thereby locking the bracket in place around the lower rung, and thereby locking the lower end of the hunting ladder guard in place, attached to the lower rung.

2. The ladder guard of claim 1, wherein the bracket is substantially u-shaped.

3. The ladder guard of claim 1, wherein the ladder guard plate is configured to be inside vertical side columns of the ladder.

4. The ladder guard of claim 3, wherein a gap width between a vertical side of the ladder guard plate and a column of the ladder is no more than one inch.

5. The ladder guard of claim 1, wherein the pad lock apertures are elongated in horizontal direction and substantially rectangular, and the upper and lower bracket legs are configured with a matching elongated, substantially rectangular shape.

6. The ladder guard of claim 1, wherein the ladder guard plate further includes at least one plate cutout, which is used as a carrying handle and for ease of positioning the ladder guard over objects protruding from the ladder.

7. The ladder guard of claim 1, wherein the ladder guard plate and the bracket are painted with a camouflage colored powder coat finish.

8. The ladder guard of claim 1, wherein the ladder guard plate has a length of substantially 34.5″and a width of substantially 11.75″.

9. The ladder guard of claim 1, wherein the ladder guard plate has a length of substantially 34.5″and a width of substantially 16″.

10. The ladder guard of claim 1, wherein each bracket aperture is substantially 1.25″ wide by substantially ¼″ high, with a distance between each of a lower edge of a first bracket aperture to the higher edge of a next-following second bracket aperture of substantially 1.75″.

11. The ladder guard of claim 1, wherein a horizontal level distance from an upper inside of the plate hook to an upper edge of a highest positioned bracket aperture is substantially 23.75″; such that the bracket is substantially 1″ wide, by substantially 1.75″ deep, by substantially 2.125″ high, with a thickness of substantially ⅛″; and further such that each bracket aperture is substantially 1.25″ wide by substantially ¼″ high, with a distance between each of a lower edge of a first bracket aperture to the higher edge of a next-following second bracket aperture of substantially 1.75″.

12. A ladder guard to prevent access to a ladder, comprising:
a. a ladder guard plate, further including
i. a plate hook, which is connected to an upper end of the ladder guard plate, such that the plate hook is configured as an inward protruding hook that attaches to a rung of the ladder; and
ii. at least two bracket apertures;
such that an upper end of ladder guard plate is attached to an upper rung of the ladder, using the plate hook, and a lower end of the ladder guard is attached to a lower rung of the ladder, such that legs of an adjustable shackle padlock are inserted through two consecutive bracket apertures, thereby locking the adjustable shackle padlock in place around the lower rung, and thereby locking the lower end of the ladder guard in place, attached to the lower rung.

13. The ladder guard of claim 12, wherein the pad lock apertures are substantially circular and the legs of the adjustable shackle padlock are configured with a matching substantially circular shape.

14. The ladder guard of claim 12, wherein the ladder guard plate is configured to be inside vertical side columns of the ladder.

15. The ladder guard of claim 14, wherein a gap width between a vertical side of the ladder guard plate and a column of the ladder is no more than one inch.

16. The ladder guard of claim 12, wherein the ladder guard plate further includes at least one plate cutout, which is used as a carrying handle and for ease of positioning the ladder guard over objects protruding from the ladder.

17. The ladder guard of claim 12, wherein the ladder guard plate is painted with a camouflage colored powder coat finish.

18. The ladder guard of claim 12, wherein the ladder guard plate has a length of substantially 34.5″and a width of substantially 11.75″.

19. The ladder guard of claim 12, wherein the ladder guard plate has a length of substantially 34.5″and a width of substantially 16″.

20. The ladder guard of claim 12, wherein a horizontal level distance from an upper inside of the plate hook to an upper edge of a highest positioned bracket aperture is substantially 23.75″; such that the bracket is substantially 1″ wide, by substantially 1.75″ deep, by substantially 2.125″ high, with a thickness of substantially ⅛″; and further such that each bracket aperture is substantially 1.25″ wide by substantially ⅛″ high, with a distance between each of a lower edge of a first bracket aperture to the higher edge of a next-following second bracket aperture of substantially 1.75″.
